(19) United States
(12) Patent Application Publication
(10) Pub. No.: US 2013/0070950 A1
(43) Pub. Date: Mar. 21, 2013

(54) MICROPHONE MODULE WITH HELMHOLTZ RESONANCE CHAMBER

(71) Applicant: HWANG-MIAW CHEN, New Taipei (TW)

(72) Inventor: HWANG-MIAW CHEN, New Taipei (TW)

(21) Appl. No.: 13/674,960

(22) Filed: Nov. 13, 2012

Related U.S. Application Data
(63) Continuation-in-part of application No. 12/758,805, filed on Apr. 13, 2010, now abandoned.
Application No. 12/758,805 is a continuation-in-part of application No. 13/272,175, filed on Oct. 12, 2011.

(30) Foreign Application Priority Data
Dec. 30, 2009 (CN) 200910312666.X
May 3, 2012 (CN) 201210133519.8

(51) Int. Cl. H04R 1/22

(52) U.S. Cl. CPC H04R 1/222
USPC 381/353

(57) ABSTRACT

An exemplary earphone module includes a faceplate, a bottom cover connected to the top cover, and a microphone received between the faceplate and the bottom cover. The faceplate defines a sound hole therein. The microphone defines a Helmholtz resonance chamber therein. A washer is placed between the faceplate and the microphone. The washer has a sound chamber communicating the sound hole with the Helmholtz resonance chamber. The Helmholtz resonance chamber has a volume V, the sound hole has a diameter d and a length l, and the sound chamber has a diameter D. The diameter D of the sound chamber meets the equation D=d or the formula

$$D \geq \sqrt{\frac{4 V}{π ( l + 0.8 d )}} .$$

### CROSS-REFERENCE TO RELATED APPLICATIONS

The present application is a continuation-in-part (CIP) application of patent application Ser. No. 13/272,175 entitled “MICROPHONE MODULE WITH HELMHOLTZ RESONANCE CHAMBER” and filed on Oct. 12, 2011, and which in turn is a continuation-in-part (CIP) application of patent application Ser. No. 12/758,805 entitled “MICROPHONE MODULE WITH HELMHOLTZ RESONANCE CHAMBER” and filed on Apr. 13, 2010, now abandoned. The disclosures of the parent applications are incorporated herein by reference in their entireties.

### BACKGROUND

1. Technical Field

The disclosure generally relates to microphones and, particularly, to a microphone module with a Helmholtz resonance chamber.

2. Description of Related Art

With the continuing development of audio and sound technology, microphones have been widely used in electronic devices such as headsets, mobile phones, computers and other devices providing audio capabilities.

A typical microphone defines a resonance chamber therein. The size of the resonance chamber determines the amount of a corresponding mass of air therein, and the quality of low frequency sound transmitted is commensurate with the amount of air. If the microphone is reduced in size, the size of the resonance chamber of the microphone and the maximum power the microphone can handle are accordingly reduced, resulting in both a reduction in loudness as well as a poorer overall quality of sound. On the other hand, increasing the size of the microphone to increase the size of the resonance chamber is not feasible in many portable device applications.

What is needed, therefore, is a means which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an assembled, isometric view of a microphone module in accordance with a first embodiment of the disclosure.

FIG. 2 is an exploded, isometric view of the microphone module of FIG. 1.

FIG. 3 is similar to FIG. 2, but viewed from an inverted aspect thereof.

FIG. 4 is a cross section of the microphone module of FIG. 1, taken along line IV-IV thereof.

FIG. 5 is a cross section of a standard Helmholtz resonance chamber.

FIG. 6 is similar to FIG. 4, but showing a cross section of a microphone module in accordance with a second embodiment of the present disclosure.

FIG. 7 is similar to FIG. 4, but showing a cross section of a microphone module in accordance with a third embodiment of the present disclosure.

FIG. 8 is similar to FIG. 4, but showing a cross section of a microphone module in accordance with a fourth embodiment of the present disclosure.

### DETAILED DESCRIPTION

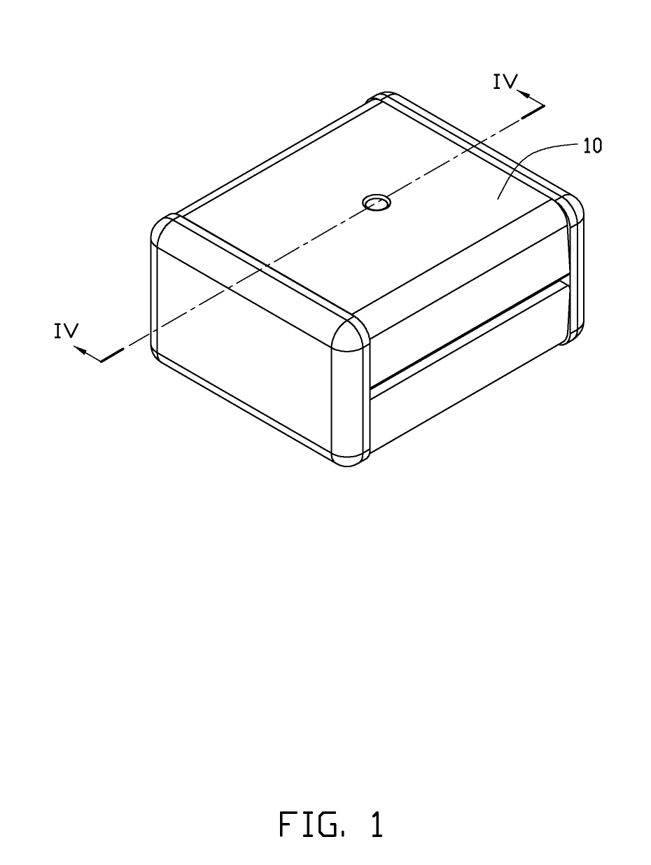

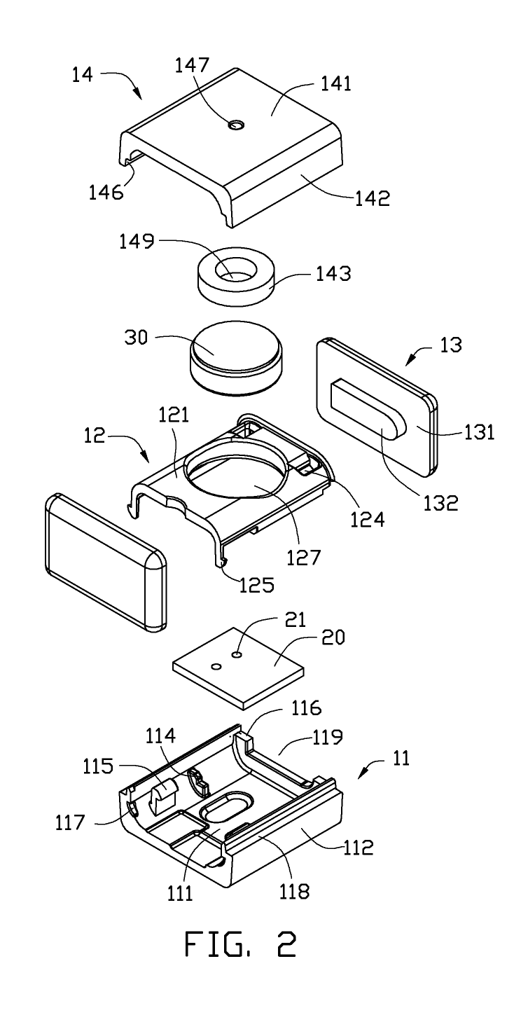

Referring to FIGS. 1 and 2, a microphone module in accordance with a first embodiment of the present disclosure is shown. The microphone module is configured for use in electronic devices such as headsets, mobile phones, computers, and others. The microphone module includes a shell 10, a circuit board 20 located in the shell 10, and a microphone 30 located on the circuit board 20 and received in the shell 10.

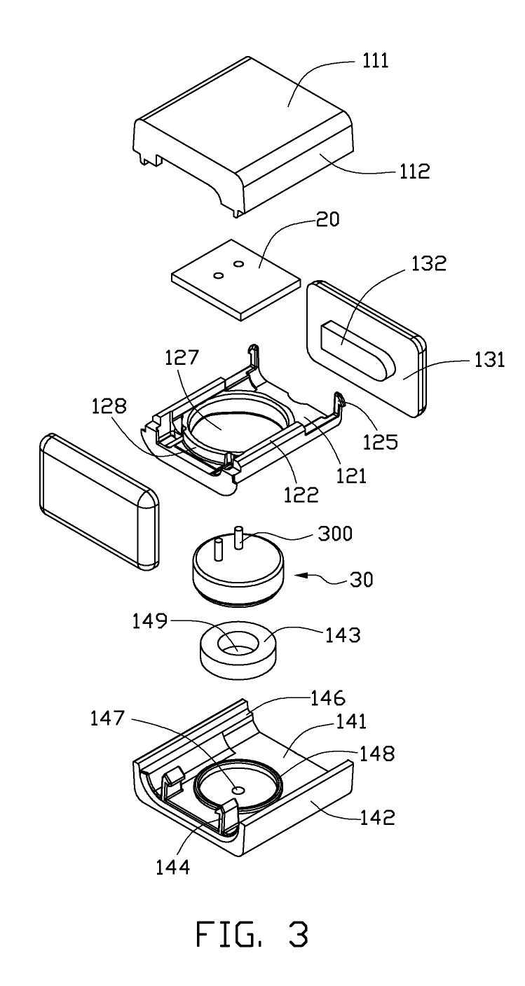

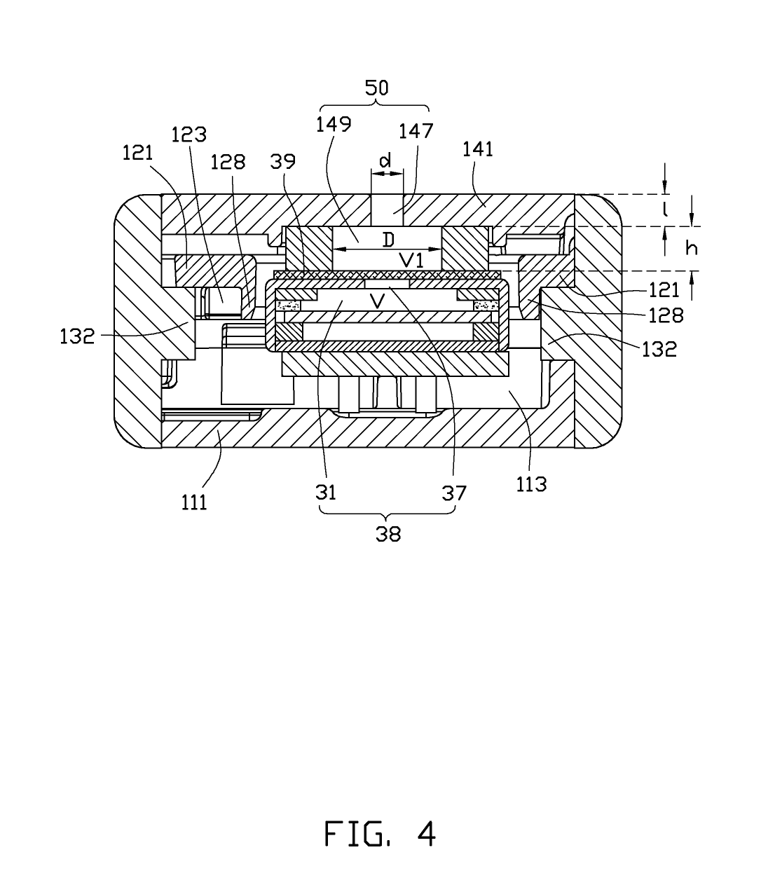

Referring also to FIGS. 3 and 4, the shell 10 includes a bottom cover 11, a top cover 12 engaging the bottom cover 11, a pair of vertical plates 13 respectively disposed at opposite ends of the bottom and top covers 11, 12, and a faceplate 14 located on the top cover 12.

The bottom cover 11 is semi-enclosed, and includes a bottom wall 111, two sidewalls 112 extending upwardly from two opposite sides of the bottom wall 111, respectively, and an engaging wall 116 extending upwardly from an end of the bottom wall 111. The bottom wall 111 and the sidewalls 112 cooperatively define a receiving chamber 113 of the bottom cover 11 (see FIG. 4). The bottom wall 111 is substantially rectangular. A pair of supporting ribs 114 and a pair of elastically deformable buckles 115 extend upwardly from the two sidewalls 112, respectively. The supporting ribs 114 support the circuit board 20 thereon, and the buckles 115 press the circuit board 20 downwardly towards the supporting ribs 114, thereby fixing the circuit board 20 within the bottom cover 11. Each of the sidewalls 112 defines a mounting groove 117 in an inner surface thereof. The mounting grooves 117 communicate with the receiving chamber 113. Each of the sidewalls 112 forms a step 118 at a top face thereof. An outer side of the step 118 is lower than an inner side of the step 118. The engaging wall 116 interconnects the two sidewalls 112. The engaging wall 116 has a height less than that of the sidewalls 112. The engaging wall 116 defines a recess 119 in a top face thereof, for engagingly receiving one of the vertical plates 13.

The top cover 12 is also semi-enclosed. The top cover 12 includes a top wall 121, and two sidewalls 122 depending downwardly from two opposite sides of the top wall 121, respectively. The top wall 121 and the sidewalls 122 cooperatively define a receiving chamber 123 in the top cover 12 (see FIG. 4).

The top wall 121 is substantially rectangular, and defines two rectangular holes 124 in two adjacent corners thereof, respectively. The top wall 121 further defines a through hole 127 in a central area thereof. The top wall 121 has an annular flange 128 extending downwardly therefrom at a circumferential edge of the through hole 127. That is, the flange 128 extends towards the bottom cover 11 (see FIG. 3).

A distance between outer surfaces of the two sidewalls 122 of the top cover 12 is equal to or slightly less than a distance between inner surfaces of the two sidewalls 112 of the bottom cover 11. A mounting hook 125 extends downwardly from a bottom face of each sidewall 122 of the top cover 12. Each mounting hook 125 is received in the mounting groove 117 of a corresponding sidewall 112 of the bottom cover 11, thereby locking the top cover 12 with the bottom cover 11.

The vertical plates 13 are made of elastic material, such as rubber. Each of the vertical plates 13 includes a base 131, and a protrusion 132 protruding inwardly from a central area of the base 131. The base 131 is rectangular, and is joined to lateral sides of the top wall 121 of the top cover 12 and the bottom wall 111 of the bottom cover 11. The protrusion 132 of one vertical plate 13 is received in the recess 119 of the bottom cover 11 in a manner that the protrusion 132 of the one vertical plate 13 is pressed downwardly by a bottom face of the top wall 121 of the top cover 12 and abuts against an outer circumferential face of the flange 128 of the top cover 12. The protrusion 132 of the other vertical plate 13 is pressed downwardly by the bottom face of the top wall 121 of the top cover 12, and is spaced from the flange 128 of the top cover 12.

The faceplate 14 includes a top plate 141, two side plates 142 extending downwardly towards the bottom cover 11 from two opposite sides of the top plate 141, respectively, and a washer 143 attached to the top plate 141.

The top plate 141 is substantially rectangular, and has a pair of engaging hooks 144, which depend downwardly toward the bottom cover 11 from a bottom face of the top plate 141. The engaging hooks 144 of the top plate 141 are engaged in the rectangular holes 124 of the top cover 12, so that the faceplate 14 is fixed to the top cover 12.

The top plate 141 defines a sound hole 147 in a center thereof. The sound hole 147 extends perpendicularly through the top plate 141, and is aligned with the through hole 127 of the top cover 12. The sound hole 147 is circular, and has a diameter far less than that of the through hole 127 of the top cover 12. The top plate 141 has an annular flange 148 extending down towards the top cover 12. The annular flange 148 surrounds the sound hole 147.

The washer 143 is annular (hollow), and made of elastic material such as sponge, rubber, or another suitable material. An outer diameter of the washer 143 is less than an inner diameter of the annular flange 148. The washer 143 is adhered to the top plate 141, and is surrounded by the annular flange 148 and a top face of the microphone 30. In a further or alternative embodiment, the washer 143 is restricted by the annular flange 148 that surrounds it. The washer 143 has a sound chamber 149 therein. An inner diameter of the washer 143, namely, a diameter of the sound chamber 149, exceeds that of the sound hole 147.

Each of the side plates 142 forms a step 146 at a bottom face thereof. An outer side of the step 146 is lower than an inner side of the step 146. The steps 146 are matched with the steps 118 of the sidewalls 112 of the bottom cover 11, so that the faceplate 14 can be fittingly engaged with the bottom cover 11.

The circuit board 20 is received in the receiving chamber 113 of the bottom cover 11 of the shell 10. The circuit board 20 forms a pair of holes 21 therein.

The microphone 30 is disposed on the top surface of the circuit board 20, and electrically connects to the circuit board 20. In this embodiment, the microphone 30 is an electret condenser microphone (ECM). The microphone 30 is cylindrical, with two pins 300 extending downwardly into the two holes 21 of the circuit board 20. The microphone 30 has an outer diameter less than an inner diameter of the through hole 127 of the top cover 12 of the shell 10. The microphone 30 defines an acoustic chamber 31 in an interior thereof, and an acoustic hole 37 in a top end thereof. The acoustic hole 37 communicates the acoustic chamber 31 with an exterior of the microphone 30. The acoustic hole 37 and the acoustic chamber 31 cooperatively form a first Helmholtz resonance chamber 38 in the microphone 30. A tuning cloth 39, made of unwoven cloth, is arranged on the acoustic hole 37. A bottom surface of the washer 143 is fixed to the tuning cloth 39. The tuning cloth 39 cooperates with the acoustic hole 37 to improve the sound quality factor and adjust the sound sharpness of the microphone 30.

In the microphone module, the washer 143 with the sound chamber 149 therein is provided between the microphone 30 and the faceplate 14, and the sound chamber 149 of the washer 143 and the sound hole 147 of the top plate 141 of the faceplate 14 cooperatively form a second Helmholtz resonance chamber 50 outside of the microphone 30. The two Helmholtz resonance chambers 38, 50 work together to improve the sound quantity of the microphone module, i.e., widening the frequency bandwidth of the sound generated by the microphone module, and lowering the lowest resonance frequency of the sound generated by the microphone module. On the other hand, an interior space of the microphone module is adequately used without increasing a volume of the microphone module.

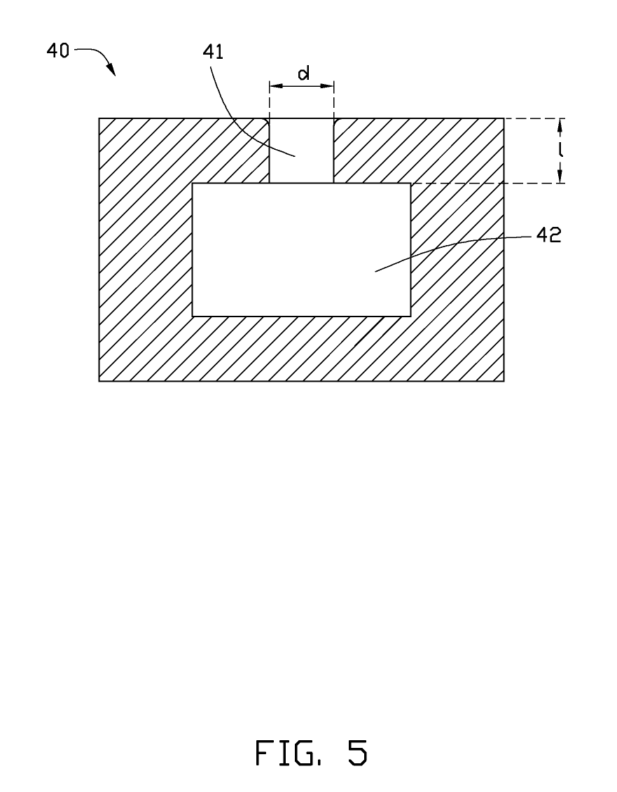

The factors of the sound chamber 149 of the washer 143, such as volume, diameter, and depth, may affect the lowest resonance frequency of the microphone module, and this directly affects the quality of the sound captured by the microphone module. Generally, the smaller the lowest resonance frequency, the better the quality of the sound captured by the microphone module. Therefore in order to choose a suitable washer 143 for the microphone module and obtain a smallest lowest resonance frequency, the factors of the sound chamber 149 must be calculated beforehand. Referring to FIG. 5, a standard Helmholtz resonance chamber 40 is introduced for reference. The standard Helmholtz resonance chamber 40 consists of a chamber 42 and a passage 41 communicating with the chamber 42. The standard Helmholtz resonance chamber 40 has a lowest resonance frequency that satisfies the formula:

$${f}_{0} = \frac{C}{2 π} \sqrt{\frac{S}{( l + 0.8 d ) V}} \qquad ( 1 )$$

In the formula (1), f₀ represents the lowest resonance frequency, C represents the sound speed (i.e., 340 meters/second), S represents a horizontal cross-sectional area of the passage 41, l represents a length (or depth) of the passage 41, d represents a diameter of the passage 41, and V represents a volume of the chamber 42.

According to the formula (1), in addition to the volume V of the chamber 42, the lowest resonance frequency f₀ is also related to the horizontal cross-sectional area S, the length l, and the diameter d of the passage 41. That is, an influence of the factors of l, d, and S with respect to f₀ may not be less than an influence of the factor of V with respect to f₀. Different situations of the microphone module of this embodiment are discussed below in light of the formula (1).

Firstly, factors of the microphone module of this embodiment are defined as follows: the first Helmholtz resonance chamber 68 has a volume V; the sound chamber 149 of the washer 143 has a volume V₁, a diameter D, and a height h; and the sound hole 147 has a horizontal cross-sectional area S, a diameter d, and a length (or depth) l.

In an extreme situation, the inner diameter of the washer 143 is reduced to make the diameter D of the sound chamber 149 equal to the diameter d of the sound hole 147. In this situation, the sound chamber 149 and the sound hole 147 can be cooperatively regarded as the passage 41 of the standard Helmholtz resonance chamber 40, and the first Helmholtz resonance chamber 38 can be regarded as the chamber 42 of the standard Helmholtz resonance chamber 40. The lowest resonance frequency f₁ of the microphone module of this embodiment in this situation is calculated as:

$${f}_{1} = \frac{C}{2 π} \sqrt{\frac{S}{( l + h + 0.8 d ) V}} \qquad ( 2 )$$

In an ordinary situation, the diameter D of the sound chamber 149 is larger than the diameter d of the sound hole 147. In this situation, only the sound hole 147 is regarded as the passage 41 of the standard Helmholtz resonance chamber 40, and the sound chamber 149 and the first Helmholtz resonance chamber 38 are cooperatively regarded as the chamber 42 of the standard Helmholtz resonance chamber 40. The lowest resonance frequency f₂ of the microphone module of this embodiment in this situation is calculated as:

$${f}_{2} = \frac{C}{2 π} \sqrt{\frac{S}{( l + 0.8 d ) ( V + {V}_{1} )}} \qquad ( 3 )$$

In order to get the result of f₂<f₁, the two formulas (2), (3) can be associated as:

(l+0.8d)(V+V₁)>(l+h+0.8d)V (4)

The formula (4) can be further concluded as:

$$\frac{{V}_{1}}{V} > \frac{h}{l + 0.8 d} \qquad ( 5 )$$

Therefore, according to the formula (5) given above, the ratio of the volume V₁ of the sound chamber 149 to the volume V of the first Helmholtz resonance chamber 38 should be larger than h/(l+0.8d), whereby the lowest resonance frequency f₂ of the ordinary situation can be ensured to be lower than the lowest resonance frequency f₁ of the extreme situation.

For a practical application of the microphone module of this embodiment, the diameter d of the sound hole 147 is generally equal to the length l of the sound hole 147, and the height h of the sound chamber 149 is about 1.31 (or 1.3d). As a result, the formula (5) can be calculated to V₁/V>0.7. Therefore, one condition to choose the washer 143 for the microphone module of this embodiment is to make V₁/V>0.7 (i.e., f₂<f₁), with the diameter D of the sound chamber 149 being larger than the diameter d of the sound hole 147. An alternative condition to choose the washer 143 is to make V₁/V<0.7 (i.e., f₁<f₂), with the diameter D of the sound chamber 149 being equal to the diameter d of the sound hole 147.

The washer 143 used in this embodiment is annular, whereby the sound chamber 149 of the washer 143 is correspondingly cylindrical. The volume V₁ of the cylindrical sound chamber 149 is expressed as

$${V}_{1} = {π ( \frac{D}{2} )}^{2} h .$$

Accordingly, the formula (5) can be varied as:

$$D > \sqrt{\frac{4 V}{π ( l + 0.8 d )}} \qquad ( 6 )$$

Thus the value of the diameter D of the sound chamber 149 is selected to be equal to the diameter d of the sound hole 147 (in the extreme situation), or larger than or identical to

$$\sqrt{\frac{4 V}{π ( l + 0.8 d )}}$$

(in the ordinary situation). That is, D=d or

$$D \geq \sqrt{\frac{4 V}{π ( l + 0.8 d )}} .$$

Any value of the diameter D of the sound chamber 149, which does not belong to such range, cannot obtain the smallest lowest resonance frequency.

Further, if the diameter D of the sound chamber 149 already meets the formula (6), it is known that the volume V₁ of the sound chamber 149 is in direct proportion to the lowest resonance frequency according to the formula (3). Therefore, a method for lowering the lowest resonance frequency is to increase the volume V₁ of the sound chamber 149.

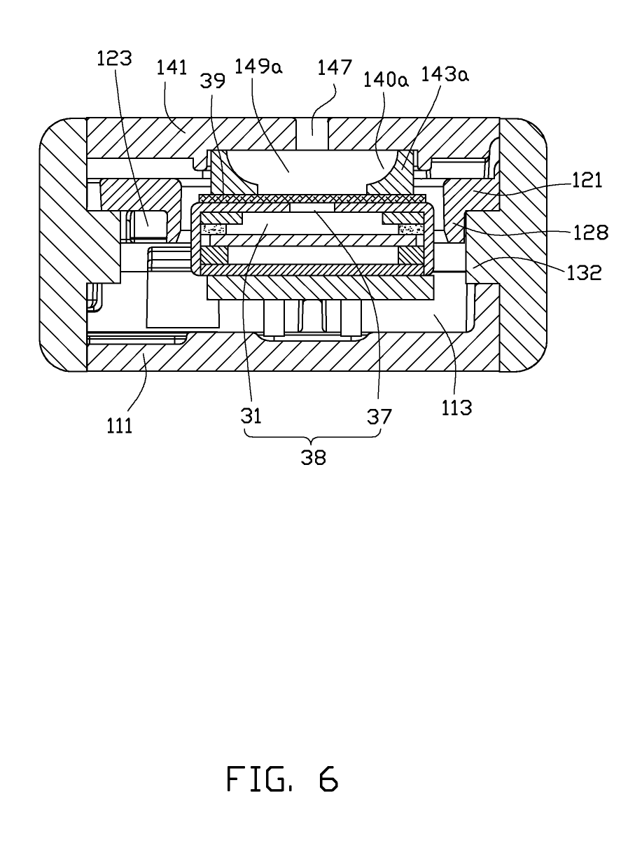

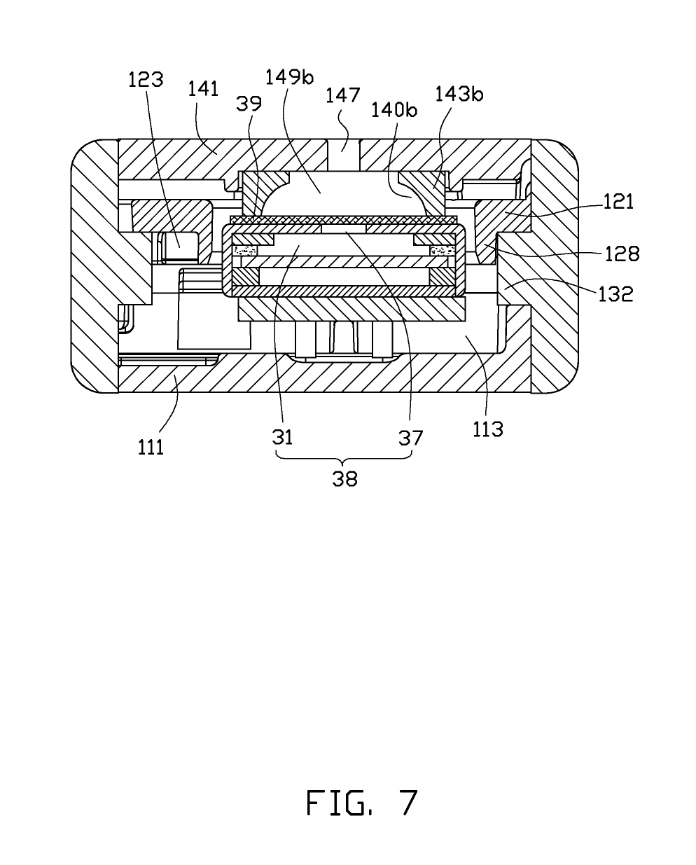

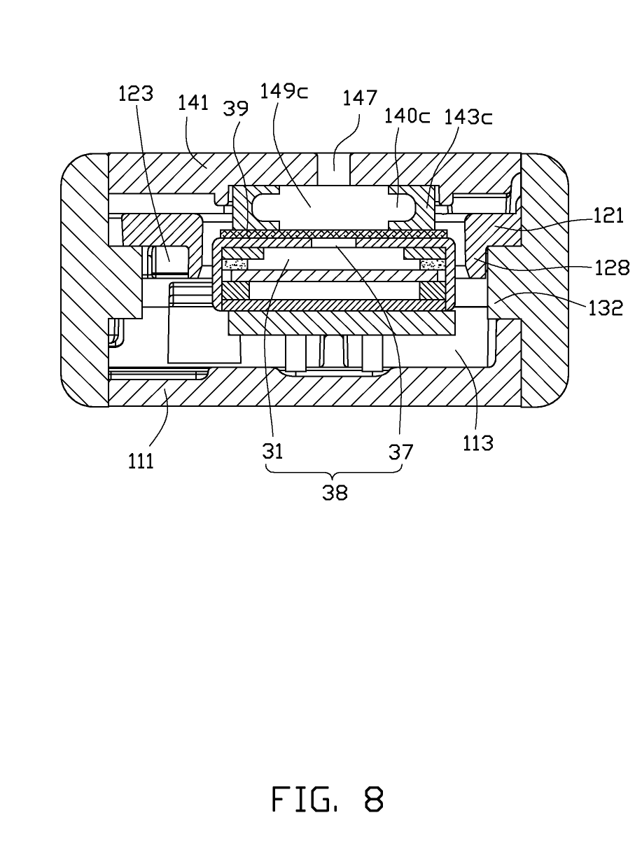

FIGS. 6-8 show various methods for increasing volumes V₁ of sound chambers 149a, 149b, 149c, without increasing spaces that washers 143a, 143b, 143c occupy. The washer 143a of FIG. 6 defines a groove 140a in an inner face thereof, the groove 140a communicating with the sound chamber 149a. The groove 140a is annular, and has a diameter gradually increasing along a bottom-to-top direction of the washer 143a. An inner face of the groove 140a is curved. The washer 143b of FIG. 7 defines a groove 140b in an inner face thereof, the groove 140b communicating with the sound chamber 149b. The groove 140b is annular, and has a diameter gradually decreasing along a bottom-to-top direction of the washer 143b. An inner face of the groove 140b is curved. The washer 143c of FIG. 8 defines a groove 140c in an inner face thereof, the groove 140c communicating with the sound chamber 149c. The groove 140c is annular, and has a diameter firstly increasing and then decreasing along a bottom-to-top direction of the washer 143c. An inner face of the groove 140c is curved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A microphone module, comprising:
a shell comprising a bottom cover and a faceplate on the bottom cover, the faceplate defining a sound hole therein;
a circuit board located in the shell;
a microphone located in the shell and electrically connected to the circuit board; and
a washer located between the microphone and the faceplate of the shell, the washer defining a sound chamber therein, the sound chamber communicating with the sound hole, the microphone defining a Helmholtz resonance chamber communicating with the sound chamber;
wherein the Helmholtz resonance chamber of the microphone has a volume V, the sound hole has a diameter d and a length l, and the sound chamber has a diameter D; and
wherein a value of the diameter D of the sound chamber is selected to meet one of the equation D=d and the formula
$$D \geq \sqrt{\frac{4 V}{π ( l + 0.8 d )}} .$$

2. The microphone module of claim 1, wherein the washer defines a groove in an inner face thereof, and the groove communicates with the sound chamber.

3. The microphone module of claim 2, wherein the groove has a diameter gradually increasing along a bottom-to-top direction of the washer.

4. The microphone module of claim 2, wherein the groove has a diameter gradually decreasing along a bottom-to-top direction of the washer.

5. The microphone module of claim 2, wherein the groove has a diameter firstly increasing and then decreasing along a bottom-to-top direction of the washer.

6. The microphone module of claim 2, wherein the groove is annular and surrounds the sound chamber.

7. The microphone module of claim 2, wherein an inner face of the groove is curved.

8. The microphone module of claim 1, wherein the faceplate comprises a top plate, two side plates extending downwardly from two opposite sides of the top plate, and an annular flange extending downwardly from the top plate, the washer being surrounded and restricted by the annular flange.

9. The microphone module of claim 8, wherein the shell comprises a top cover between the faceplate and the bottom cover, and the top cover comprises a top wall defining a through hole receiving the microphone.

10. The microphone module of claim 9, wherein the top wall of the top cover defines two holes, and the faceplate comprises two engaging hooks extending downwardly from the top plate, the two engaging hooks being locked in the two holes of the top cover, respectively.

11. The microphone module of claim 10, wherein the two engaging hooks are located adjacent to the two side plates of the top plate, respectively.

12. The microphone module of claim 9, wherein the top wall of the top cover forms an annular flange extending downwardly corresponding to the through hole, the microphone being surrounded by the annular flange of the top cover.

13. The microphone module of claim 12, wherein the bottom cover comprises a bottom wall and two sidewalls extending upwardly from the bottom wall, the two sidewalls of the bottom cover engaging with the two side plates of the faceplate, respectively.

14. The microphone module of claim 13, wherein each sidewall of the bottom cover defines a mounting groove, and the top cover comprises two mounting hooks each locked in a corresponding mounting groove of the bottom cover.

15. The microphone module of claim 13, wherein the bottom cover comprises two supporting ribs and two buckles formed on the sidewalls, and the circuit board is supported by the two supporting ribs and downwardly pressed by the two buckles.

16. The microphone module of claim 13, wherein the shell further comprises two vertical plates mounted to two opposite sides of the bottom cover, respectively.

17. The microphone module of claim 16, wherein each vertical plate comprises a base and a protrusion protruding inwardly from the base, the protrusion of one vertical plate abutting against the annular flange of the top cover, and the protrusion of the other vertical plate being spaced from the annular flange of the top cover.

18. The microphone module of claim 17, wherein the bottom cover comprises an engaging wall extending upwardly from the bottom wall, and the engaging wall defines a recess partially receiving the protrusion of the one vertical plate.

19. The microphone module of claim 1, wherein the microphone comprises two pins inserted in the circuit board.

20. The microphone module of claim 1, wherein the sound hole, the sound chamber and the Helmholtz resonance chamber are aligned with each other.
